(19) United States
(12) Patent Application Publication
(10) Pub. No.: US 2024/0363970 A1
(43) Pub. Date: Oct. 31, 2024

(54) BUS BAR MEMBER AND MANUFACTURING METHOD OF BUS BAR MEMBER

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Shintaro MORINO, Osaka-shi, Osaka (JP); Yasushi TAMURA, Osaka-shi, Osaka (JP); Yusuke MITSUGI, Osaka-shi, Osaka (JP)

(21) Appl. No.: 18/556,455

(22) PCT Filed: Apr. 22, 2022
(86) PCT No.: PCT/JP2022/018543

§ 371 Date: Oct. 20, 2023

(30) Foreign Application Priority Data
Apr. 23, 2021 (JP) 2021-072988

(51) Int. Cl. H01M 50/505; H01M 50/503; H01M 50/526; H01M 50/591

(52) U.S. Cl. CPC H01M 50/505; H01M 50/503; H01M 50/526; H01M 50/591

(57) ABSTRACT

Provided is a configuration that makes it easy to secure the electrical insulation for a bus bar member for covering a bus bar that includes a straight portion and a bent portion, with a coating member and a manufacturing method of the bus bar member. A bus bar member includes: a bus bar that includes a straight portion and a bent portion, and an insulation coating member that covers the bus bar. The coating member includes: a first coating portion that covers a portion of the straight portion, and a second coating portion that covers a portion of the bent portion that is not covered with the first coating portion, and is different from the first coating portion. An end portion of the second coating portion overlaps an end portion of the first coating portion.

### CROSS-REFERENCE TO RELATED APPLICATIONS

This application is the U.S. national stage of PCT/JP2022/018543 filed on Apr. 22, 2022, which claims priority of Japanese Patent Application No. JP 2021-072988 filed on Apr. 23, 2021, the contents of which are incorporated herein.

### TECHNICAL FIELD

The present disclosure relates to a bus bar member and a manufacturing method of the bus bar member.

### BACKGROUND

Conductive members such as bus bars are used in a state of being coated and insulated. The cable portion disclosed in WO 2017/69209 includes a conductive portion formed of an electrically conductive material such as metal, and an insulation coating that covers the conductive portion, for example. The cable portion includes a bent portion formed by bending the cable portion in a direction orthogonal to the extending direction of a straight portion.

As disclosed in WO 2017/69209, when the structure of the conductive portion covered with the coating is bent, there is a risk that the coating on the bent portion will be creased, broken, or the like. When the coating is creased, broken, or the like, the problem may arise that the electrical insulation of the conductive portion cannot be secured.

The present disclosure provides a configuration that makes it easy to secure the electrical insulation of a bus bar member, to a bus bar member for covering a bus bar that includes a straight portion and a bent portion, with a coating member, and to a manufacturing method of the bus bar member.

### SUMMARY

A bus bar member according to the present disclosure includes: a bus bar that includes a straight portion and a bent portion, and an insulation coating member that covers the bus bar. The coating member includes a first coating portion that covers at least a portion of the straight portion, and a second coating portion that covers a portion of the bent portion that is not covered with the first coating portion, and is different from the first coating portion, and at least a portion on an end portion side of the second coating portion overlaps a portion on an end portion side of the first coating portion.

A manufacturing method of a bus bar member according to the present disclosure is a manufacturing method of a bus bar member for covering a bus bar with an insulation coating member, the bus bar includes a straight portion and a bent portion, the coating member includes a first coating portion that covers at least a portion of the straight portion and a second coating portion that covers a portion of the bent portion that is not covered with the first coating portion. The method includes covering at least a portion of the straight portion with the first coating portion, bending a portion of the bus bar that is different from the straight portion so as to form the bent portion, and covering the bent portion with the second coating portion such that the second coating portion overlaps a portion on an end portion side of the first coating portion.

### Advantageous Effects of the Present Disclosure

A bus bar member according to the present disclosure makes it easy to secure the electrical insulation in a configuration in which a bus bar that includes a straight portion and a bent portion is covered with a coating member.

### BRIEF DESCRIPTION OF DRAWINGS

FIG. 1 is a perspective view of a battery pack according to a first embodiment of the present disclosure.

FIG. 2 is a plan view of one end of a bus bar member as viewed from the thickness direction.

FIG. 3 is an explanatory view illustrating a manufacturing process of the bus bar member.

FIG. 4 is an explanatory view illustrating a manufacturing process of a conventional bus bar member.

FIG. 5 is an explanatory view illustrating a manufacturing process of a bus bar member according to a second embodiment of the present disclosure.

FIG. 6 is a plan view of a bus bar member according to another embodiment of the present disclosure as viewed from the thickness direction.

### DETAILED DESCRIPTION OF PREFERRED EMBODIMENTS

Embodiments of the present disclosure will be listed and described below. Note that characteristics in (1) to (4) to be illustrated below may be combined in any manner as long as no contradictions arise. Characteristics in (5) to (7) to be illustrated below may be combined in any manner as long as no contradictions arise.

A bus bar member including a bus bar that includes a straight portion and a bent portion, and an insulation coating member that covers the bus bar, the coating member including: a first coating portion that covers at least a portion of the straight portion, and a second coating portion that covers a portion of the bent portion that is not covered with the first coating portion, and is different from the first coating portion, and at least a portion on an end portion side of the second coating portion overlapping a portion on an end portion side of the first coating portion.

In this bus bar member, the second coating portion that is different from the first coating portion covers a portion of the bent portion that is not covered with the first coating portion, and thus the configuration of the second coating portion is unlikely to affect the first coating portion. In this state, the portion on the end portion side of the second coating portion overlaps the portion on the end portion side of the first coating portion, and thus it is possible to keep the bus bar from being exposed between the first coating portion and the second coating portion. This makes it easy to secure the electrical insulation of the bus bar member.

The bus bar member according to the present disclosure may be used in a battery pack.

With this configuration, the bus bar member can be applied to a bus bar that is used in a battery pack and through which a large current is likely to flow.

In the bus bar member according to the present disclosure, an end portion on the bent portion side of the straight portion may include a portion that is not covered with the first coating portion.

With this configuration, attachment of a fixture and the like can be performed using the portion at the end portion on the bent portion side of the straight portion, the portion not being covered with the first coating portion, and the first coating portion can be kept from being affected by the attachment of a fixture and the like.

In the bus bar member according to the present disclosure, the bent portion may be bent in a direction along a plate surface of the straight portion.

In a configuration in which the bent portion is bent in a direction along the plate surface of the straight portion, the degree of bending of an inner circumferential portion is large, an outer circumferential portion stretches largely, and thus the second coating portion is likely to deform or the like. Therefore, by applying the configuration of the second coating portion (configuration in which the second coating portion is a coating portion different from the first coating portion) to the bent portion formed as described above, the effect of making it less likely for deformation of the second coating portion to affect the first coating portion is exerted noticeably.

A manufacturing method of a bus bar member for covering a bus bar with an insulation coating member, the bus bar including a straight portion and a bent portion, the coating member including a first coating portion that covers at least a portion of the straight portion and a second coating portion that covers a portion of the bent portion that is not covered with the first coating portion, and the method including, covering at least a portion of the straight portion with the first coating portion, bending a portion of the bus bar that is different from the straight portion so as to form the bent portion, and covering the bent portion with the second coating portion such that the second coating portion overlaps a portion on an end portion side of the first coating portion.

This manufacturing method of the bus bar member can keep the coating portion from being creased, broken, and the like due to a bending process of the bus bar, by forming the bent portion in the bus bar and then forming the second coating portion that covers the bent portion. In this state, the portion on the end portion side of the second coating portion overlaps the portion on the end portion side of the first coating portion, and thus it is possible to keep the bus bar from being exposed between the first coating portion and the second coating portion. This makes it easy to secure the electrical insulation of the bus bar member.

In the manufacturing method of the bus bar member according to the present disclosure, the first coating portion may be formed by extrusion molding.

With this configuration, by using extrusion molding for forming the first coating portion, it is possible to reduce the cost when forming the first coating portion, and to simplify the process.

The manufacturing method of the bus bar member according to the present disclosure, including: covering at least a portion of the straight portion with the first coating portion and further covering an adjacent portion adjacent to at least a portion of the straight portion with an adjacent coating portion, removing the adjacent coating portion, bending the adjacent portion so as to form the bent portion, and covering the bent portion with the second coating portion such that the second coating portion overlaps a portion on an end portion side of the first coating portion.

When the adjacent portion in a state of being covered with the adjacent coating portion is bent, there is a risk that the adjacent coating portion will be creased, broken, and the like. Therefore, by removing the adjacent coating portion in advance and then covering the bent portion with the second coating portion, the bent portion can be covered with the second coating portion that is kept from being creased, broken, and the like.

### First Embodiment

### Configuration of Bus Bar Member

A bus bar member 10 according to a first embodiment is a large

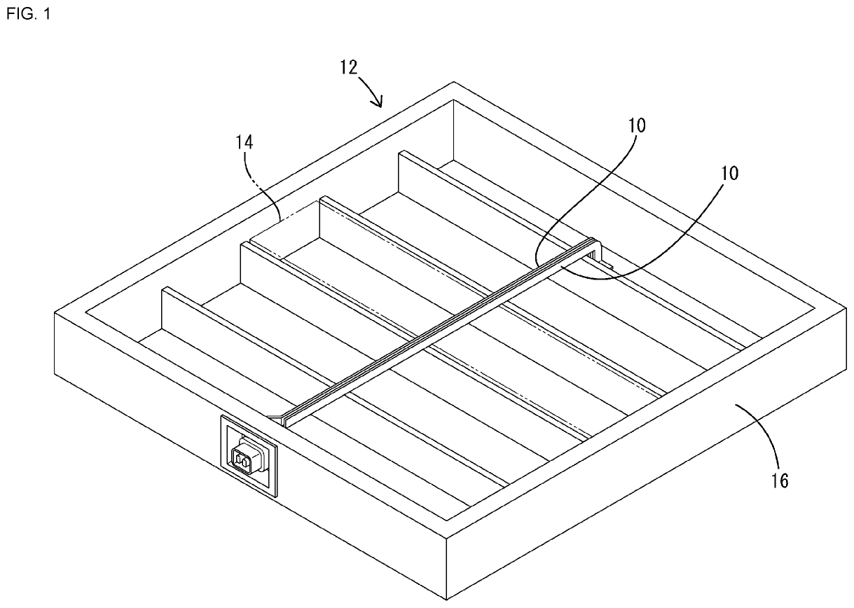

current bus bar member. The bus bar member 10 is used in a vehicle such as an electric automobile or a hybrid automobile. As shown in FIG. 1, for example, the bus bar member 10 is used in a battery pack 12 mounted in a vehicle such as an electric automobile or a hybrid automobile. The battery pack 12 has, a plurality of battery modules 14 accommodated in a case 16. Note that FIG. 1 shows only one battery pack 12. The battery modules 14 are aggregation of a plurality of battery cells. In the example in FIG. 1, the bus bar member 10 is used as an electrical power path for taking out electrical power from the battery modules 14. Note that the bus bar member 10 can also be used as an electrical power path that connects electrodes between battery modules 14, for example.

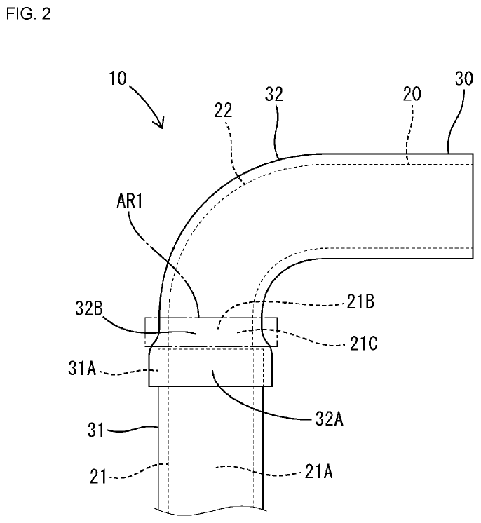

As shown in FIG. 2, the bus bar member 10 includes a bus bar 20 and a coating member 30. The bus bar 20 is a conductive member made of a conductive material (aluminum, copper, etc.). The bus bar 20 is formed by punching a metal plate, for example. The bus bar 20 is shaped as a flattened plate. The bus bar 20 includes a straight portion 21 and a bent portion 22. The straight portion 21 is a portion extending in a predetermined direction, and includes a pair of parallel edges. The bent portion 22 is a portion that is bent from the straight portion 21. That is to say, the bent portion 22 is a portion extending so as to be bent from an end portion 21B of the straight portion 21. The bent portion 22 is bent in a direction along a plate surface 21A of the straight portion 21. The bent portion 22 has a so-called edge-wise bent shape (shape obtained by bending the long sides of a cross-section of the straight portion 21 in the lateral direction). The inner edge (edge on the inner circumferential side) and the outer edge (edge on the outer circumferential side) of the bent portion 22 are curved.

As shown in FIG. 2, the coating member 30 covers the bus bar 20. The coating member 30 is insulative. The coating member 30 is made of a flexible resin, for example. The coating member 30 includes a first coating portion 31 and a second coating portion 32. The first coating portion 31 covers a portion of the straight portion 21. The first coating portion 31 does not cover the bent portion 22. The end portion 21B on the bent portion 22 side of the straight portion 21 (a portion adjacent to the bent portion 22) includes a portion that is not covered with the first coating portion 31 (a first non-coated portion 21C). The first non-coated portion 21C is a portion surrounded by the dashed-dotted line AR1 in FIG. 2. The first non-coated portion 21C is provided over the entire periphery of the end portion 21B. In this manner, by providing the first non-coated portion 21C in the straight portion 21, attachment of a fixture and the like can be performed using the first non-coated portion 21C, and it is possible to keep the first coating portion 31 from being affected by attachment of a fixture and the like.

As shown in FIG. 2, the second coating portion 32 is a coating portion different from the first coating portion 31. The second coating portion 32 covers a portion of the bent portion 22 that is not covered with the first coating portion 31 (in FIG. 2, the entire bent portion 22). The second coating portion 32 covers a portion of the first coating portion 31 and a portion of the straight portion 21. Specifically, the second coating portion 32 covers an end portion 31A on the bent portion 22 side of the first coating portion 31. An end portion 32A on the straight portion 21 side of the second coating portion 32 covers the end portion 31A of the first coating portion 31 over the entire periphery thereof. That is to say, the end portion 32A of the second coating portion 32 overlaps the end portion 31A of the first coating portion 31 over the entire periphery thereof.

As shown in FIG. 2, the second coating portion 32 covers the first non-coated portion 21C of the straight portion 21. Specifically, a portion (an adjacent portion 32B) of the second coating portion 32 that is adjacent to the end portion 32A covers the first non-coated portion 21C over the entire periphery thereof.

As shown in FIG. 2, a configuration is adopted in which a portion of the straight portion 21 is covered with the first coating portion 31 and the bent portion 22 is covered with the second coating portion 32, and thus, compared with a configuration in which the first coating portion 31 and the second coating portion 32 are integrated (configuration in which the first coating portion 31 and the second coating portion 32 are continuous without any break), the first coating portion 31 is unlikely to be affected by the second coating portion 32. It is possible to make it less likely for a change in the shape of the second coating portion 32 to affect the shape of the first coating portion 31, for example.

With a configuration in which the bent portion 22 is bent in a direction along the plate surface of the straight portion 21, the degree of bending of the inner circumferential edge of the bent portion 22 is large, and the outer circumferential edge of the bent portion 22 stretches largely. Therefore, the second coating portion 32 that covers the bent portion 22 is likely to deform or the like. By applying the configuration of the second coating portion 32 (configuration in which the second coating portion 32 is a coating portion different from the first coating portion 31) to the bent portion 22 formed in this manner, the effect of making it less likely for deformation or the like of the second coating portion 32 to affect the first coating portion 31 is exerted noticeably.

As shown in FIG. 2, a configuration is adopted in which the end portion 32A of the second coating portion 32 and the end portion 31A of the first coating portion 31 overlap, and thus the bus bar 20 can be kept from being exposed between the first coating portion 31 and the second coating portion 32. It is possible to keep a gap from being formed between the second coating portion 32 and the first coating portion 31 so as to expose the bus bar 20, for example. That makes it easy to secure the electrical insulation of the bus bar member 10.

### Manufacturing Method of Bus Bar Member

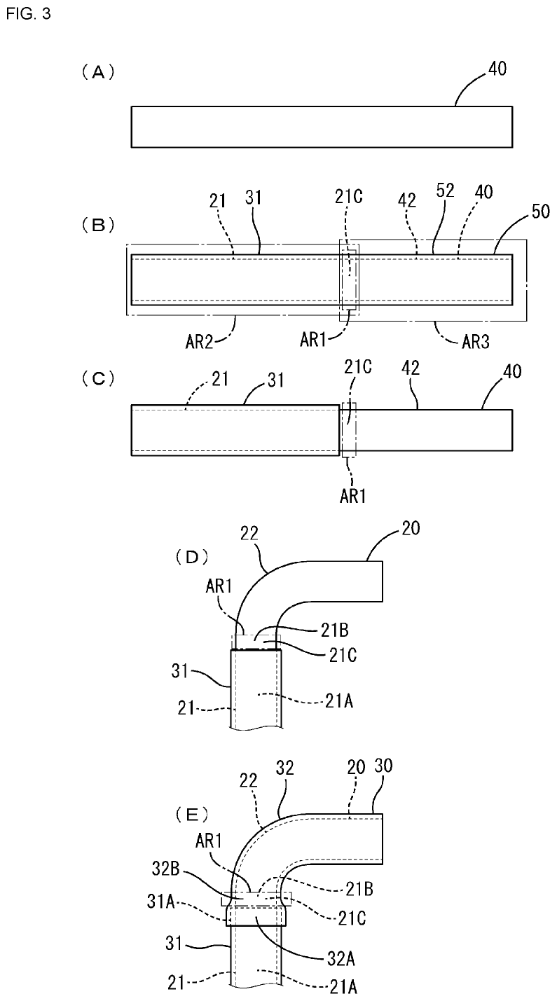

Next, a manufacturing method of the bus bar member 10 will be described. First, as shown in FIG. 3(A), a linear bus bar 40 is prepared. Next, as shown in FIG. 3(B), the entirety in the lengthwise direction of the bus bar 40 (the entire periphery excluding the two end surfaces) is covered with an entirely-coating portion 50. The entirely-coating portion 50 is electrically insulative. The entirely-coating portion 50 is formed of a flexible resin, for example. The entirely-coating portion 50 is formed by extrusion molding, for example. The entirely-coating portion 50 is formed by disposing a tubular insulative member so as to cover the peripheral surface of the bus bar 40 by extrusion molding, and subjecting the tubular insulative member to thermal shrinking, for example. By using extrusion molding for forming the entirely-coating portion 50 in this manner, the cost can be reduced, and the process can be simplified.

A portion of the bus bar 40 that is included in the region surrounded by the dashed-dotted line AR2 shown in FIG. 3(B) corresponds to the straight portion 21. The region surrounded by the dashed-dotted line AR2 includes the first non-coated portion 21C (region surrounded by the dashed-dotted line AR1). A portion of the bus bar 40 that is included in the region surrounded by the dashed-dotted line AR3 shown in FIG. 3(B) is defined as an adjacent portion 42 that is adjacent to a portion of the straight portion 21 (that excludes the first non-coated portion 21C). A portion of the entirely-coating portion 50 that is included in the region surrounded by the dashed-dotted line AR3 shown in FIG. 3(B) is defined as an adjacent coating portion 52 that covers the adjacent portion 42.

Next, as shown in FIG. 3(C), the adjacent coating portion 52 is removed from the adjacent portion 42. Accordingly, the first coating portion 31 that covers a portion of the straight portion 21 (that excludes the first non-coated portion 21C) is formed. At the same time, the first non-coated portion 21C is formed in a portion (the region AR1) surrounded by the dashed-dotted line in FIG. 3(C).

Next, as shown in FIG. 3(D), a portion (the adjacent portion 42) of the bus bar 40 that is different from the straight portion 21 is bent so as to form the bent portion 22. The bent portion 22 is formed so as to be bent from the end portion 21B of the straight portion 21. The bent portion 22 is formed by bending the bus bar 40 in a direction along the plate surface 21A of the straight portion 21. The bent portion 22 is formed by so-called edge-wise bending (bending the long sides of a cross-section of the straight portion 21 in the lateral direction). The bent portion 22 can be formed using a fixture attached to the first non-coated portion 21C, for example.

Next, as shown in FIG. 3(E), the bent portion 22 is covered with the second coating portion 32 such that the second coating portion 32 overlaps the end portion 31A on the bent portion 22 side of the first coating portion 31 and a portion of the second coating portion 32 that is adjacent to the end portion 32A (the adjacent portion 32B). Specifically, the second coating portion 32 is formed such that the end portion 32A covers the end portion 31A of the first coating portion 31 and the adjacent portion 32B covers the first non-coated portion 21C. Here, the end portion 32A of the second coating portion 32 overlaps the end portion 31A of the first coating portion 31 over the entire periphery thereof. The second coating portion 32 is formed, for example, by covering the bent portion 22 with a tubular insulative member, and subjecting the tubular insulative member to thermal shrinking. By removing the adjacent coating portion 52 in advance and covering the bent portion 22 with the second coating portion 32, the bent portion 22 can be covered with the second coating portion 32 that is kept from being creased, broken, and the like. The end portion 32A of the second coating portion 32 overlaps the end portion 31A of the first coating portion 31, and thus the bus bar 20 can be kept from being exposed between the first coating portion 31 and the second coating portion 32. This makes it easy to secure the electrical insulation of the bus bar member 10. The bus bar member 10 is manufactured as described above.

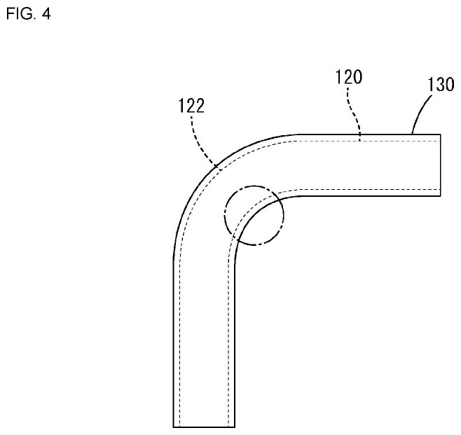

FIG. 4 is an explanatory view illustrating a conventional manufacturing method of a bus bar member. In a conventional manufacturing method of a bus bar member, as shown in FIG. 4, a configuration is adopted in which a bus bar 120 is covered with a coating member 130, and the bus bar 120 covered with the coating member 130 is then bent to form a bent portion 122. That is to say, a configuration is adopted in which a coating portion that covers the bent portion 122 is formed in advance before the bent portion is formed. With such a configuration, a portion of the coating member 130 that covers the bent portion 122 is likely to be creased, broke, and the like due to the bus bar being bent. Particularly, in a configuration in which the bent portion is bent in a direction along the plate surface of the straight portion, the degree of bending of the inner circumferential portion is large, and the outer circumferential portion stretches largely, and thus the coating member is likely to deform or the like. A portion of the coating member that covers an inner circumferential portion of the bent portion 122 (a portion surrounded by the dashed-dotted line in FIG. 4) is likely to be creased, for example. In this manner, in a conventional manufacturing method of a bus bar member, it is difficult to secure the processing accuracy of the coating member that covers the bent portion 122. On the other hand, in the manufacturing method of the bus bar member according to the present disclosure, a configuration is adopted in which the bent portion 22 is formed in the bus bar 20, and the second coating portion 32 that covers the bent portion 22 is then formed. Therefore, in the manufacturing method of the bus bar member according to the present disclosure, the second coating portion 32 is not affected by a bending process of the bus bar 20, and thus the coating portion can be kept from being creased, broken, and the like due to the bending process of the bus bar 20.

In the manufacturing method of the bus bar according to the present disclosure, a configuration is adopted in which the coating member 30 is separated into the first coating portion 31 and the second coating portion 32, and a portion of the straight portion 21 is covered with the first coating portion 31 before the bent portion 22 is formed. Therefore, when the first coating portion 31 is formed, the bus bar 20 (particularly, the bent portion 22) does not need to be inserted into a relatively long tubular insulative member, and the manufacturing method can be simplified.

### Exemplary Effects

The following description relates to the effects of the first embodiment.

With the bus bar member 10 according to the present disclosure, the second coating portion 32 that is different from the first coating portion 31 covers a portion of the bent portion 22 that is not covered with the first coating portion 31, and thus the configuration of the second coating portion 32 does not affect the first coating portion 31. A portion (the end portion 32A) on the end portion side of the second coating portion 32 overlaps a portion (the end portion 31A) on the end portion side of the first coating portion 31 in this state, and thus the bus bar 20 can be kept from being exposed between the first coating portion 31 and the second coating portion 32. This makes it easy to secure the electrical insulation of the bus bar member 10.

The bus bar member 10 according to the present disclosure is used in the battery pack 12. Accordingly, the bus bar member 10 can be applied to a bus bar that is used in the battery pack 12 and through which a large current is likely to flow.

In the bus bar member 10 according to the present disclosure, the end portion 21B on the bent portion 22 side of the straight portion 21 includes a portion that is not covered with the first coating portion 31 (the first non-coated portion 21C). Accordingly, attachment of a fixture and the like can be performed using the first non-coated portion 21C, and the first coating portion 31 can be kept from being affected by attachment of a fixture and the like.

In the bus bar member 10 according to the present disclosure, the bent portion 22 is bent in a direction along the plate surface 21A of the straight portion 21. In a configuration in which the bent portion 22 is bent in a direction along the plate surface 21A of the straight portion 21, the degree of bending of the inner circumferential portion is large, and the outer circumferential portion stretches largely, and thus the second coating portion 32 is likely to deform or the like. Therefore, by applying the configuration of the second coating portion 32 (configuration in which the second coating portion 32 is a coating portion different from the first coating portion 31) to the bent portion 22 formed in this manner, the effect of making it less likely for deformation or the like of the second coating portion 32 to affect the first coating portion 31 is exerted noticeably.

In the manufacturing method of the bus bar member 10 according to the present disclosure, a portion of the straight portion 21 is covered with the first coating portion 31, a portion of the bus bar 20 that is different from the straight portion 21 is bent so as to form the bent portion 22, and the bent portion 22 is covered with the second coating portion 32 such that the second coating portion 32 overlap a portion (the end portion 31A) on the end portion side of the first coating portion 31. By forming the bent portion 22 in the bus bar 20 and then forming the second coating portion 32 that covers the bent portion 22 in this manner, the coating portion can be kept from being creased, broken, and the like due to a bending process of the bus bar 20. In this state, a portion (the end portion 32A) on the end portion side of the second coating portion 32 overlaps a portion (the end portion 31A) on the end portion side of the first coating portion 31, and thus the bus bar 20 can be kept from being exposed between the first coating portion 31 and the second coating portion 32. This makes it easy to secure the electrical insulation of the bus bar member 10.

In the manufacturing method of the bus bar member 10 according to the present disclosure, the first coating portion 31 is formed by extrusion molding. Accordingly, by using extrusion molding for forming the first coating portion 31, it is possible to reduce the cost when forming the first coating portion 31, and to simplify the process.

In the manufacturing method of the bus bar member 10 according to the present disclosure, the straight portion 21 is covered with the first coating portion 31, the adjacent portion 42 adjacent to the straight portion 21 is covered with the adjacent coating portion 52, the adjacent coating portion 52 is removed, and the adjacent portion 42 is bent so as to form the bent portion 22. When the adjacent portion 42 in a state of being covered with the adjacent coating portion 52 is bent, there is a risk that the adjacent coating portion 52 will be creased, broken, and the like. Therefore, by removing the adjacent coating portion 52 in advance and then covering the bent portion 22 with the second coating portion 32, the bent portion 22 can be covered with the second coating portion 32 that is kept from being creased, broken, and the like.

### Second Embodiment

The following description relates to a manufacturing method of a bus bar member according to a second embodiment.

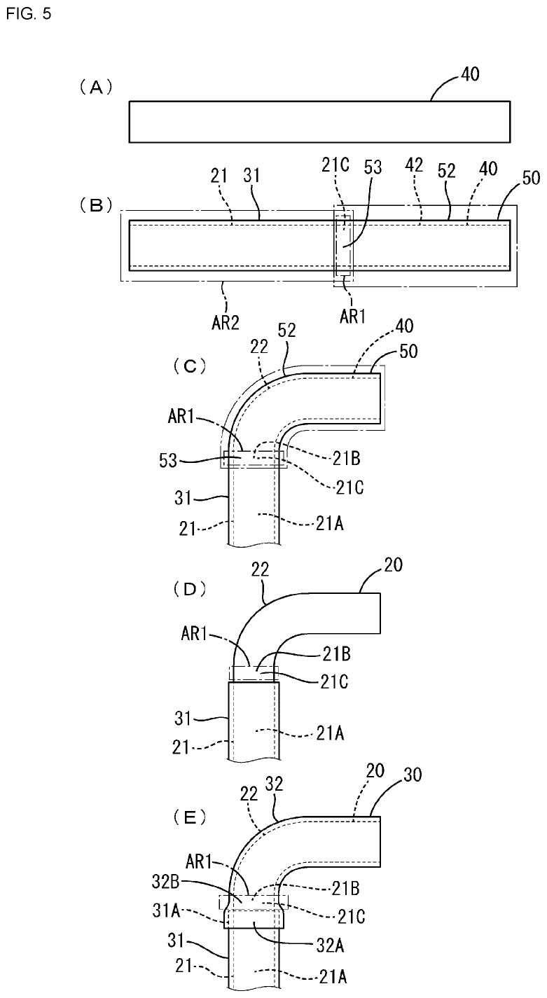

The manufacturing method of the bus bar member shown in FIG. 5 is different from the first embodiment only in a process of removing the adjacent coating portion 52, and except for that, the second embodiment is the same as the first embodiment. Thus, in description of the manufacturing method of the bus bar member according to the second embodiment, portions that have the same configurations as those of the first embodiment are given the same reference numerals as the first embodiment, and a detailed description thereof is omitted.

As shown in FIG. 5(A), in the manufacturing method of the bus bar member according to the second embodiment, first, the linear bus bar 40 is prepared similarly to the first embodiment. Next, as shown in FIG. 5(B), the entirety in the lengthwise direction of the bus bar 40 (the entire periphery excluding the two end surfaces) is covered with the entirely-coating portion 50, similarly to the first embodiment.

Next, as shown in FIG. 5(C), a portion (the adjacent portion 42) of the bus bar 40 that is different from the straight portion 21 is bent so as to form the bent portion 22. The shape of the bent portion 22 is similar to the shape of the bent portion 22 formed in the first embodiment. At this time, a fixture can be attached to a portion (a central portion 53) of the entirely-coating portion 50 that covers the first non-coated portion 21C. The central portion 53 is a portion surrounded by the dashed-dotted line AR1 shown in FIGS. 5(B) and 5(C). Accordingly, even when the central portion 53 is damaged due to attachment of the fixture or the like, the central portion 53 is removed in a subsequent process, and thus the electrical insulation of the bus bar member 10 can be secured without being hindered.

Next, as shown in FIG. 5(D), the adjacent coating portion 52 is removed from the bent portion 22. Accordingly, the first coating portion 31 that covers a portion of the straight portion 21 (portion that excludes the first non-coated portion 21C) is formed.

Next, as shown in FIG. 5(E), the second coating portion 32 is formed using a method similar to that in the first embodiment. The bus bar member 10 is manufactured in the above-described manner. Also with such a manufacturing method, the effects similar to those of the first embodiment can be exerted.

### Other Embodiments

The present disclosure is not limited to the embodiments described above and with reference to the drawings. Any combination of characteristics in the embodiments described above and below can be made as long as no contradictions arise. In addition, any characteristics in the embodiment described above and below can be omitted unless explicitly stated as essentials. Furthermore, the above embodiments may be changed as follows.

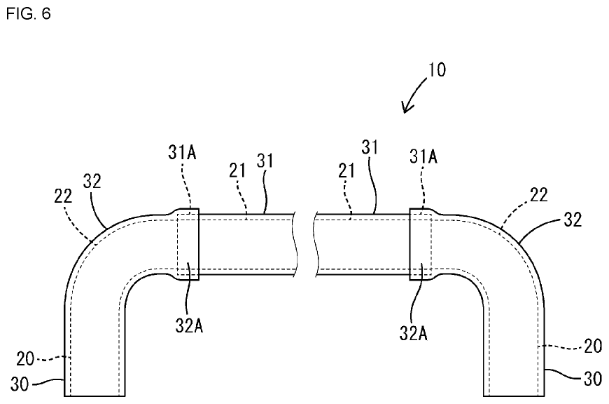

In the first embodiment, the configuration of one end of the bus bar member 10 has been illustrated, but, as shown in FIG. 6, a configuration may also be adopted in which the two ends of the bus bar member 10 are bent. Also with such a configuration, it is easy to secure the electrical insulation of the bus bar member 10 in a state where the configuration of the second coating portion 32 does not affect the first coating portion 31.

In the first embodiment, a configuration is adopted in which the end portion 32A of the second coating portion 32 overlaps the end portion 31A of the first coating portion 31, but a configuration may also be adopted in which at least one of the second coating portion 32 and the first coating portion 31 overlaps a region of the other coating portion that is larger than the end portion thereof.

In the first embodiment, the first coating portion 31 covers a portion of the straight portion 21 that excludes the first non-coated portion 21C, but a configuration may also be adopted in which the first non-coated portion 21C is also covered.

In the first embodiment, the second coating portion 32 covers the entire bent portion 22, but a configuration may also be adopted in which the second coating portion 32 covers a portion of the bent portion 22.

In the first embodiment, the bent portion 22 is bent in a direction along the plate surface of the straight portion 21, but a configuration may also be adopted in which the bent portion 22 is bent in another direction.

1. A bus bar member comprising:
a bus bar that includes a straight portion and a bent portion; and
an insulation coating member that covers the bus bar,
wherein the coating member includes:
a first coating portion that covers at least a portion of the straight portion, and
a second coating portion that covers a portion of the bent portion that is not covered with the first coating portion, and is different from the first coating portion, and
at least a portion on an end portion side of the second coating portion overlaps a portion on an end portion side of the first coating portion.

2. The bus bar member according to claim 1,
wherein the bus bar member is used in a battery pack.

3. The bus bar member according to claim 1,
wherein an end portion on the bent portion side of the straight portion includes a portion that is not covered with the first coating portion.

4. The bus bar member according to claim 1,
wherein the bent portion is bent in a direction along a plate surface of the straight portion.

5. A manufacturing method of a bus bar member for covering a bus bar with an insulation coating member,
wherein the bus bar includes a straight portion and a bent portion,
the coating member includes a first coating portion that covers at least a portion of the straight portion and a second coating portion that covers a portion of the bent portion that is not covered with the first coating portion,
the method comprising:
covering at least a portion of the straight portion with the first coating portion;
bending a portion of the bus bar that is different from the straight portion so as to form the bent portion; and
covering the bent portion with the second coating portion such that the second coating portion overlaps a portion on an end portion side of the first coating portion.

6. The manufacturing method of the bus bar member according to claim 5, wherein the first coating portion is formed by extrusion molding.

7. The manufacturing method of the bus bar member according to claim 5, comprising:
covering at least a portion of the straight portion with the first coating portion and further covering an adjacent portion adjacent to at least a portion of the straight portion with an adjacent coating portion;
removing the adjacent coating portion;
bending the adjacent portion so as to form the bent portion; and
covering the bent portion with the second coating portion such that the second coating portion overlaps a portion on an end portion side of the first coating portion.

8. The bus bar member according to claim 2,
wherein an end portion on the bent portion side of the straight portion includes a portion that is not covered with the first coating portion.

9. The bus bar member according to claim 2,
wherein the bent portion is bent in a direction along a plate surface of the straight portion.

10. The bus bar member according to claim 3,
wherein the bent portion is bent in a direction along a plate surface of the straight portion.

11. The manufacturing method of the bus bar member according to claim 6, comprising:
covering at least a portion of the straight portion with the first coating portion and further covering an adjacent portion adjacent to at least a portion of the straight portion with an adjacent coating portion;
removing the adjacent coating portion;
bending the adjacent portion so as to form the bent portion; and
covering the bent portion with the second coating portion such that the second coating portion overlaps a portion on an end portion side of the first coating portion.
